(19) United States
(12) Patent Application Publication
(10) Pub. No.: US 2016/0120132 A1
(43) Pub. Date: May 5, 2016

(54) PRUNING SHEARS

(71) Applicant: FORMOSA TOOLS CO., LTD., Changhua (TW)

(72) Inventor: WEI-CHUN HSU, Changhua (TW)

(21) Appl. No.: 14/532,019

(22) Filed: Nov. 4, 2014

(51) Int. Cl. A01G 3/02

(52) U.S. Cl. CPC A01G 3/021

(57) ABSTRACT

A pair of pruning shears is revealed. The pruning shears include a first brake arm, a second brake arm, a blade, and at least one connection piece. The first brake arm is disposed with a first toothed part while the second brake arm is arranged with a second toothed part. The first toothed part and the second toothed part are engaged with each other. The connection pieces are connected to the blade, the first brake arm, and the second brake arm. During a cutting process, a force applied is reduced due to the connection piece pivotally connected to the first brake arm and the second brake arm. While the first and the second toothed parts are engaged with each other, the connection piece becomes a wall of the first and the second toothed parts for stabilizing the engagement of the first and the second toothed parts.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to pruning shears used in gardening, especially to pruning shears for trimming hard branches of trees, plants and fences. A stronger cutting force is required for pruning these plants so that the present invention provides a cutting structure with features of labor-saving and stability.

2. Description of Related Arts

Refer to EP1827770, a pair of clippers, especially hedge clippers, is revealed. Disclosed are manually operated clippers, especially hedge clippers, comprising a toothed gear (ZG, ZS) that is located between a first handle arm (GA1) and a first clipper arm (S1). The second handle arm (GA2) is hingedly connected to the second clipper arm (S2) while a coupling lever (HE) is provided between the second handle arm (S2) and the first handle arm (GA1) and/or the first clipper arm (S1) such that the handle arms and the blades can be swiveled in a largely symmetrical manner when the clippers are opened and closed even though the coupling structure encompassing only one toothed gear (ZG, ZS) is asymmetrical. In addition, the entire amount of force that is transmitted between the actuated handle arms and the blades can be influenced via the coupling lever. The patent is related to a pair of manually operated clippers and the force transmitted between a brake handle arm and a blade can be reduced through a connecting rod.

However, there is only one side of the engagement part between the toothed gears (ZG, ZS) being closed while the other side is opened, without any wall or covering. An upper end of the first dipper arm S1 becomes a wall for closing one side of the engagement part between the toothed gears (ZG, ZS). During the trimming of hard branches of plants, the blades may be unable to fit each other closely and the cutting is not smooth. A reaction force split the blades is also transmitted to the toothed gears (ZG, ZS) therebetween. Thus the toothed gears (ZG, ZS) are against and separated from each other due to the reaction force. Therefore the toothed gears (ZG, ZS) are unable to engage with each other normally. In another condition, the hard branches of the plants may be inserted into the toothed gears (ZG, ZS) through the open side. This also results in that the toothed gears (ZG, ZS) are unable to mesh smoothly.

### SUMMARY OF THE PRESENT INVENTION

Therefore it is a primary object of the present invention to provide a pruning shears that is more labor-saving and stable during cutting process. The pruning shears is a labor-saving device that combines a gear transmission device, linkage and lever. A first brake arm and a second brake arm are acted and moved stably by engagement of a first toothed part with a second toothed part. Furthermore, a first connection piece and a second connection piece are used to support the first brake arm and the second brake arm for increasing force transmitted.

In order to achieve the above object, a pruning shears of the present invention includes a first brake arm, a second brake arm, a blade, a first connection piece, and a second connection piece. The first brake arm is formed by a first toothed part and a first handle part while the second brake arm is arranged with a second toothed part and a second handle part. The first toothed part and the second toothed part are engaged with each other. One end of the first connection piece is connected to the blade while the other end thereof is pivotally connected to the second brake arm. The first connection piece is used as a link. One end of the second connection piece is pivotally connected to the first brake arm while the other end thereof is pivotally connected to the second brake arm. The second connection piece is used as a lever so as to reduce the force required during cutting of the blade. Moreover, the projecting part of the blade and the second connection piece work as walls covering the first toothed part and the second toothed part during engagement so as to stabilize the engagement of the first toothed part with the second toothed part.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a front view of an embodiment according to the present I invention;

FIG. 3 is a rear view of an embodiment according to the present I invention;

FIG. 4 is a schematic drawing showing an embodiment being opened according to the present I invention;

FIG. 5 is another schematic drawing showing an embodiment being opened according to the present I invention.

### DETAILED DESCRIPTION OF THE PREFERRED EMBODIMENT

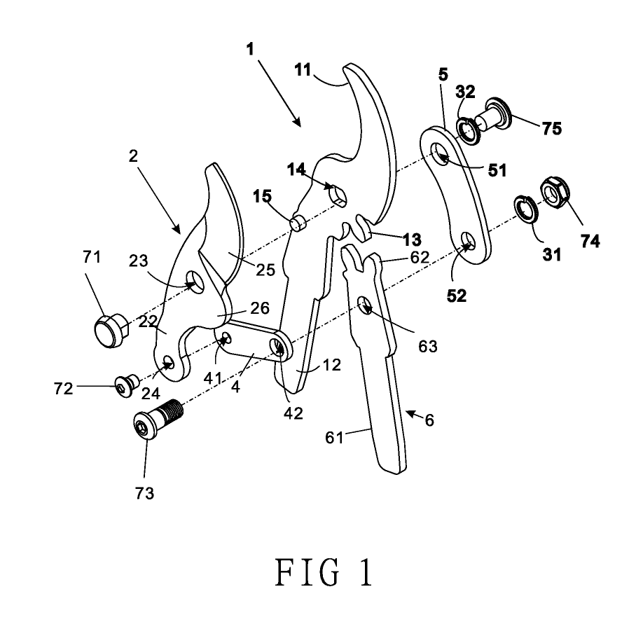

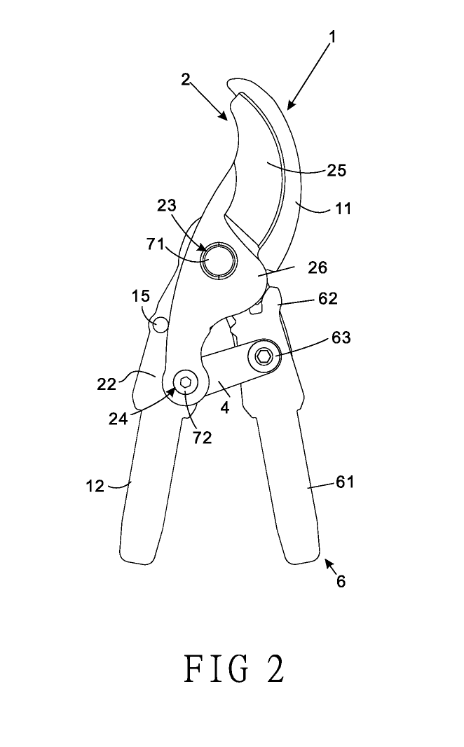

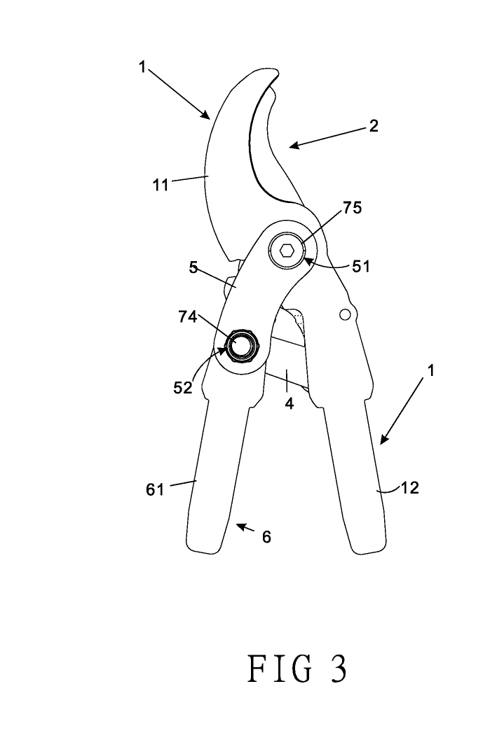

Refer to FIG. 1, FIG. 2 and FIG. 3, a pruning shears of the present invention includes a first brake arm 1, a blade 2, a first connection piece 4, a second connection piece 5 and a second brake arm 6. The first brake arm 1 consists of a first toothed part 13, a first handle part 12 and a blunt part 11. An axial part 14 and a stopping part 15 are disposed under the blunt part 11 while the first toothed part 13 is arranged between the blunt part 11 and the first handle part 12. The second brake arm 6 is formed by a second handle part 61, a second toothed part 62, and a first assembly part 63 set between the second handle part 61 and the second toothed part 62. The first toothed part 13 and the second toothed part 62 are engaged with each other. The blade 2 includes a connection part 22, a first assembly part 23, a second assembly part 24, a blade part 25, and a projecting part 26. The first assembly part 23 and the second assembly part 24 are arranged at the connection part 22. The connection piece 4 includes a first pivot part 41 and a second pivot part 42 while the second connection piece 5 consists of a third pivot part 51 and a fourth pivot part 52. A bolt 72 is inserted through the second assembly part 24 of the blade 2 and the first pivot part 41 of the connection piece 4 and then is riveted. The second pivot part 42 of the connection piece 4 is pivotally connected to the first assembly part 63 of the second brake arm 6 by a bolt 73 passed therethrough. A bolt 71 is first inserted through the first assembly part 23 of the blade 2, then passed through the first axial part 14 of the first brake arm 1, the third pivot part 51 of the second connection piece 5 and a ring fastener 32 to be fastened by a nut 75. After being inserted through the first assembly part 63 of the second brake arm 6, the bolt 73 is further passed through the fourth pivot part 52 of the second connection piece 5 and a ring fastener 31 to be screwed into a nut 74.

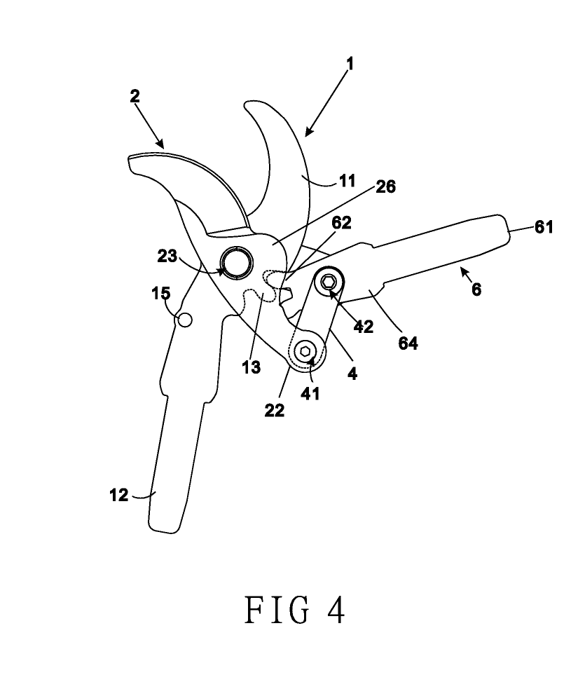

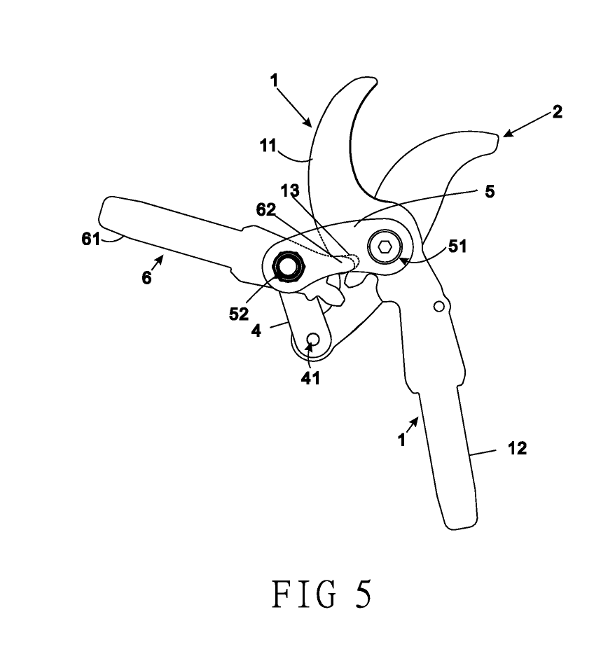

Refer to FIG. 4, FIG. 5 and FIG. 6, the projecting part 26 of the blade 2 and the second connection piece 5 clip the first toothed part 13 and the second toothed part 62 therebetween. The projecting part 26 of the blade 2 becomes a front wall covering the engaged first toothed part 13 and the second toothed part 62 while the second connection piece 5 is a rear wall on the opposite side. When the first toothed part 13 and the second toothed part 62 are engaged with other, the clipping of the projecting part 26 of the blade 2 and the second connection piece 5 can stabilize the engagement between the first toothed part 13 and the second toothed part 62 and keep the engagement therebetween running smoothly. It should be noted that the second connection piece 5 can be moved like a pendulum. While the first toothed part 13 is engaged with the second toothed part 62, the second connection piece 5 is also moved along with the engagement part where the first toothed part 13 and the second toothed part 62 are engaged with each other for covering the engagement part.

The first pivot part 41 of the connection piece 4 is connected to the second assembly part 24 of the blade 2 in a fixed manner and unable to pivot while the second pivot part 42 of the connection piece 4 is pivotally connected to the first assembly part 63 of the second brake arm 6 and able to turn on pivotally. The assembly of the second assembly part 24 of the blade 2 with the first pivot part 41 of the first connection piece 4 is by the bolt 72 passed therethrough and then to be riveted while the bolt 73 is inserted through the second pivot part 42 of the connection piece 4 and the first assembly part 63 of the second brake arm 6 for pivotal connection. Moreover, due to that the first connection piece 4 is connected to the second brake arm 6 and riveted to the second assembly part 24 of the blade 2, unable to turn on pivotally, the first connection piece 4 not only connects the blade 2 and the second brake arm 6, but also shortens a push stroke of the second brake arm 6 that pushes the blade 2.

As shown in FIG. 6, the present invention features on that the movement and the engagement between the first toothed part 13 and the second toothed part 62 are stabilized by the second connection piece 5 and the projecting part 26 of the blade 2. The projecting part 26 of the blade 2 and the second connection piece 5 form a front wall and a rear wall respectively, covering the first toothed part 13 and the second toothed part 62 therebetween. The first connection piece 4 is connected to the blade 2 and the second brake arm 6 so that the first connection piece 4 becomes a crank extended from the blade 2. The second pivot part 42 is pivotally connected to the second brake arm 6 so that the second brake arm 6 becomes a lever of the first connection piece 4. Thus the first connection piece 4 can push the connection part 22 of the blade 2. Therefore the open and close stoke is shortened and the force required for cutting is reduced when the second brake arm 6 and the first brake arm 1 are opened or closed for pruning. At the same time, the first connection piece 4, together with the first brake arm 1 and the second brake arm 6 forms a linkage structure so as to save labor. The second connection piece 5 supports the first brake arm 1 and the second brake arm 6 to increase the force transmitted. The design and the structure allow the cutting process more labor saving and stable and this is another structural features of the present invention.

Furthermore, the pruning shears of the present invention is designed based on the linkage and lever. The second connection piece 5 is a link and the second brake arm 6 is a rocker. Two ends of the first connection piece 4 are connected to the blade 2 and the second brake arm 6 respectively. The actuating path the second brake arm 6 can push or pull is extended. When the second brake arm 6 works as a link, the third pivot part 51 is the fulcrum. When a force is applied to the second brake arm 6, the engagement part where the first toothed part 13 and the second toothed part 62 are engaged is the fulcrum. When the second handle part 61 of the second brake arm 6 is driven to move, the first toothed part 13 and the second toothed part 62 are engaged. The second connection piece 5 is relatively moved in a pendulum manner. At the same time, the first connection piece 4 pivotally connected to the second handle part 61 of the second brake arm 6 is also pushed to move and against the blade 2. Thus the blade 2 is wobbled and moved to cut. The fulcrum for the blade 2 is the first assembly part 23 while the second assembly part 24 under the fulcrum is the point the force is applied. That means the first connection piece 4 pushes the connection part 22 of the blade 2 under the fulcrum. The connection part 22 is the lever arm while the first connection piece 4 is pushed by the second brake arm 6. By the stroke the second brake arm 6 pushes the blade 2 and the first connection piece 4 pivotally connected to the second brake arm 6, the force applied to the second handle part 61 and the first handle part 12 of the first brake arm 1 is reduced. In other words, while the second brake arm 6 and the first brake arm 1 are opened and closed for cutting, the pivotally connection position of the first pivot part 41 (the second assembly part 24) is lower than that of the first assembly part 63 (the second pivot part 42) in the view of the horizontal plane. Thus the first connection piece 4 having one end fixed on the second assembly part 24 of the blade 2 and the other end pivotally connected to the first assembly part 63 of the second brake arm 6 forms a lever between the blade 2 and the second brake arm 6.

The first assembly part 63 is used for connecting the second brake arm 6. By the first connection piece 4 extended and coupled to the connection part 22 of the blade, the first connection piece 4 becomes a crank of the blade 2 and the length of the lever arm of the blade 2 is increased. Together with the length of the lever arm of the second brake arm 6, the total length of the lever arm is larger than the length of the resistance lever arm of the blade 2 (the blade part 25). Thus the force required for operating the second brake arm 6 is significantly reduced.

In addition, the stopping part 15 under the blunt part 11 provides the stopping function. As shown in FIG. 2, the pruning shears are closed. The connection part 22 of the blade 2 is pushed toward the first handle part 12 by the second handle part 61 and is unable to be moved any more until the connection part 22 is in contact with the stopping part 15. The closing movement between the blade 2 and the blunt part 11 is finished.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A pruning shears, comprising:
a first brake arm having a first toothed part, a first handle part, a blunt part and an axial part;
a second brake arm disposed with a second toothed part, a second handle part and a first assembly part;
a blade which is arranged with a connection part, a first assembly part, a second assembly part and a projecting;
a first connection piece having a first pivot part and a second pivot part;
a second connection piece having a third pivot part and a fourth pivot part;
wherein the second assembly part of the blade is connected to the first pivot part of the connection piece by a bol, wherein the second pivot part of the connection piece is pivotally connected to the first assembly part of the second brake arm by a bolt, wherein the first assembly part of the blade, the first axial part of the first brake arm and the third pivot part of the second connection piece are pivotally connected by a bolt passed therethrough and then a ring fastener is fitted over the bolt, wherein the bolt is fastened by a nut, wherein the first assembly part of the second brake arm is pivotally connected to the fourth pivot part of the second connection piece by the bolt, wherein a ring fastener is fitted over the bolt and the bolt is screwed into a nut, wherein the first toothed part and the second toothed part are engaged with each other.

2. The pruning shears, as claimed in claim 1, wherein a stopping part is disposed under the blunt part.

3. The pruning shears, as claimed in claim 1, wherein the first toothed part is arranged between the blunt part and the first handle part while the second toothed part is disposed on one end of the second brake arm.

4. A pruning shears, comprising: a first brake arm, a blade, a first connection piece, a second connection piece and a second brake arm, wherein the first brake arm is disposed with a first toothed part, a first handle part, and a blunt part while the second brake arm is arranged with a second toothed part, a second handle part and a first assembly part, the blade further includes a connection part, a first assembly part, a second assembly part and a projecting part, wherein the first connection piece having a first pivot part and a second pivot part, the second connection piece having a third pivot part and a fourth pivot part, wherein the second pivot part of the connection piece is pivotally connected to the first assembly part of the second brake arm, the second assembly part of the blade is connected to the first pivot part of the connection piece while the first assembly part of the blade, the first axial part of the first brake arm and the third pivot part of the second connection piece are pivotally connected, wherein the first assembly part of the second brake arm and the fourth pivot part of the second connection piece are pivotally connected, wherein the first toothed part and the second toothed part are engaged with each other, wherein the projecting part of the blade and the second connection piece clip an engagement part where the first toothed part and the second toothed part are engaged with each other horizontally, when the first toothed part and the second toothed part are engaged with each other, the projecting part of the blade and the second connection piece can stabilize the engagement between the first toothed part and the second toothed part to keep the engagement therebetween running smoothly.

5. A pruning shears, comprising: a first brake arm, a blade, a first connection piece, a second connection piece and a second brake arm 6, wherein a second pivot part of the connection piece is pivotally connected to a first assembly part of the second brake arm, wherein a second assembly part of the blade is connected to a first pivot part of the connection piece while a first assembly part of the blade, a first axial part of the first brake arm and a third pivot part of the second connection piece are pivotally connected, wherein the first assembly part of the second brake arm and a fourth pivot part of the second connection piece are pivotally connected, a first toothed part and a second toothed part are engaged with each other, wherein the blade further includes a connection part, a first assembly part, a second assembly part and a projecting part, wherein the projecting part of the blade and the second connection piece are clipped an engagement part where the first toothed part and the second toothed part are engaged with each other horizontally.

6. The pruning shears, as claimed in claim 5, wherein a stopping part is arranged under the blunt part.
